(19) United States
(12) Patent Application Publication
(10) Pub. No.: US 2025/0053839 A1
(43) Pub. Date: Feb. 13, 2025

(54) CONTROLLING CROSS-TALK AND BUS LOSSES IN RABI-DRIVEN SUPERCONDUCTING QUBITS WITH MULTI-MODE INTERCONNECTS

(71) Applicant: International Business Machines Corporation, Armonk, NY (US)

(72) Inventors: Aaron Finck, White Plains, NY (US); Cihan Kurter, White Plains, NY (US); Muir Kumph, Croton on Hudson, NY (US); Kentaro Heya, Yokohama (JP)

(21) Appl. No.: 18/447,412

(22) Filed: Aug. 10, 2023

(51) Int. Cl. G06N 10/40

(52) U.S. Cl. CPC G06N 10/40

(57) ABSTRACT

Devices and/or computer-implemented methods facilitating suppression of cross-talk between qubits are provided. In an embodiment, a device can comprise a first transmon qubit coupled to a first tunable coupled qubit (TCQ) interconnect, wherein each pad of the first transmon qubit are coupled to corresponding outer pads of the first TCQ interconnect; a second transmon qubit coupled to a second TCQ interconnect, wherein each pad of the second transmon qubit are coupled to corresponding outer pads of the second TCQ interconnect; and a middle pad of the first TCQ interconnect coupled to a middle pad of the second TCQ interconnect, wherein the coupling comprises each middle pad coupled to a resonator.

### BACKGROUND

The subject disclosure relates to a quantum device, and more specifically, to a quantum device facilitating suppression of cross-talk between qubits.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices, computer-implemented methods, and/or computer program products that facilitate suppression of cross-talk between qubits are described.

According to an embodiment, a device can comprise a first transmon qubit coupled to a first tunable coupled qubit (TCQ) interconnect, wherein each pad of the first transmon qubit are coupled to corresponding outer pads of the first TCQ interconnect; a second transmon qubit coupled to a second TCQ interconnect, wherein each pad of the second transmon qubit are coupled to corresponding outer pads of the second TCQ interconnect; and a middle pad of the first TCQ interconnect coupled to a middle pad of the second TCQ interconnect, wherein the coupling comprises each middle pad coupled to a resonator. An advantage of such a device is that it can enable operation of entangling gates between the first transmon qubit and the second transmon qubit, while suppressing cross-talk between the qubits, thereby improving performance.

In some embodiments, the device can further comprise a third transmon qubit coupled to a third TCQ interconnect, wherein each pad of the third transmon qubit are coupled corresponding outer pads of the third TCQ interconnect, and wherein a middle pad of the third TCQ interconnect is coupled to the resonator. An advantage of such a device is that it can enable operation of entangling gates between the first transmon qubit, the second transmon qubit and the third transmon qubit, while suppressing cross-talk between the qubits, thereby improving performance.

According to another embodiment, a device can comprise a transmon qubit coupled to a first TCQ interconnect and a second TCQ interconnect, wherein each pad of the transmon qubit are coupled to corresponding outer pads of the first TCQ interconnect and corresponding outer pads of the second TCQ interconnect; a first resonator bus coupled to a middle pad of the first TCQ interconnect; and a second resonator bus coupled to a middle pad of the second TCQ interconnect. An advantage of such a device is that it can enable greater scalability in quantum devices due to the use of two resonator buses while suppressing cross-talk, thereby improving performance.

In some embodiments of the device, at least one of the first resonator bus or the second resonator bus can comprise a superconducting qubit. An advantage of such a device is that it can yield a bus with a higher quality factor than can be achieved with other resonator types and reduces the possibility of populating the resonator with long-lived photons.

According to another embodiment, a device can comprise a transmon bus comprising a first pad and a second pad; and a TCQ interconnect, wherein the first pad of the transmon bus is coupled to a middle pad of the TCQ interconnect. An advantage of such a device is that it can enable greater scalability in quantum devices.

In some embodiments, the device can comprise a first operating mode that enables exchange coupling between a transmon qubit and the TCQ interconnect, and a second operating mode that enables exchange coupling between the TCQ interconnect and the resonator bus. An advantage of such a device is that it can suppress cross-talk associated with the transmon qubit, thereby improving performance.

### DESCRIPTION OF THE DRAWINGS

FIG. 1 illustrates a top view of an example, non-limiting, TCQ interconnect that can facilitate suppression of cross-talk in accordance with one or more embodiments described herein.

FIG. 2 illustrates an alternative top view of an example TCQ interconnect that can facilitate suppression of cross-talk in accordance with one or more embodiments described herein.

FIG. 3 illustrates a first oscillating mode structure and a second oscillating mode structure of a TCQ interconnect in accordance with one or more embodiments described herein.

FIG. 4 illustrates a top view of an example, non-limiting device 400 that can facilitate suppression of cross-talk between qubits in accordance with one or more embodiments described herein.

FIG. 5 illustrates a top-down view of an example, non-limiting device that can facilitate suppression of cross-talk between qubits in accordance with one or more embodiments described herein.

FIG. 6 illustrates a top-down view of an example, non-limiting, device that facilitates suppression of cross-talk in accordance with one or more embodiments described herein.

FIG. 7 illustrates a top down view of an example, non-limiting device that facilitates all-to-all connectivity between multiple qubits with suppression of cross-talk in accordance with one or more embodiments described herein.

FIG. 8 illustrates a top-down view of an example, non-limiting, device that facilitates suppression of cross-talk of qubits and scalability of number of qubits in accordance with one or more embodiments described herein.

FIG. 9 illustrates a top-down view of an example, non-limiting, device that facilitates suppression of cross-talk of qubits and scalability of number of qubits in accordance with one or more embodiments described herein.

FIG. 10 illustrates a flow diagram of an example, non-limiting computer-implemented method can facilitate cross-talk suppression between qubits in accordance with one or more embodiments described herein.

FIG. 11 illustrates an example, non-limiting environment for the execution of at least some of the computer code in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Quantum computing is generally the use of quantum-mechanical phenomena for the purpose of performing computing and information processing functions. Quantum computing can be viewed in contrast to classical computing, which generally operates on binary values with transistors. That is, while classical computers can operate on bit values that are either 0 or 1, quantum computers operate on quantum bits (qubits) that comprise superpositions of both 0 and 1, can entangle multiple quantum bits, and use interference.

Within quantum computing, if multiple superconducting qubits are connected to a single bus, such as a coplanar waveguide resonator, an entangling Molmer-Sorensen gate can be realized by Rabi-driving the qubits. This permits all-to-all connectivity with reduced constraints on the frequencies of the qubits, thereby enabling faster and/or cheaper production of quantum computing devices. However, cross-talk between qubits connected to the same bus might not be negligible. This cross-talk can take the form of exchange interactions (e.g., energy transport between qubits, such that driving one qubit with a single-gate qubit could cause unwanted excitations of another qubit) and longitudinal interactions (e.g., the state of one qubit can shift the transition frequency of another qubit). In either case, cross-talk has a significant impact on the accuracy and usability of quantum devices as such cross-talk inhibits individual control of the qubits with single-qubit gates and can lead to unintended changes excitations of qubits. Furthermore, the fidelity of the entangling gate can be limited by the quality factor of the bus.

Given the problems described above with prior art technologies, the present disclosure can be implemented to produce a solution to these problems in the form of devices and/or computer-implemented methods that can facilitate suppression of cross-talk between qubits by employing a device comprising a first transmon qubit coupled to a first tunable coupled qubit (TCQ) interconnect, wherein each pad of the first transmon qubit are coupled to corresponding outer pads of the first TCQ interconnect; a second transmon qubit coupled to a second TCQ interconnect, wherein each pad of the second transmon qubit are coupled to corresponding outer pads of the second TCQ interconnect; and a middle pad of the first TCQ interconnect coupled to a middle pad of the second TCQ interconnect, wherein the coupling comprises each middle pad coupled to a resonator.

It will be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling.

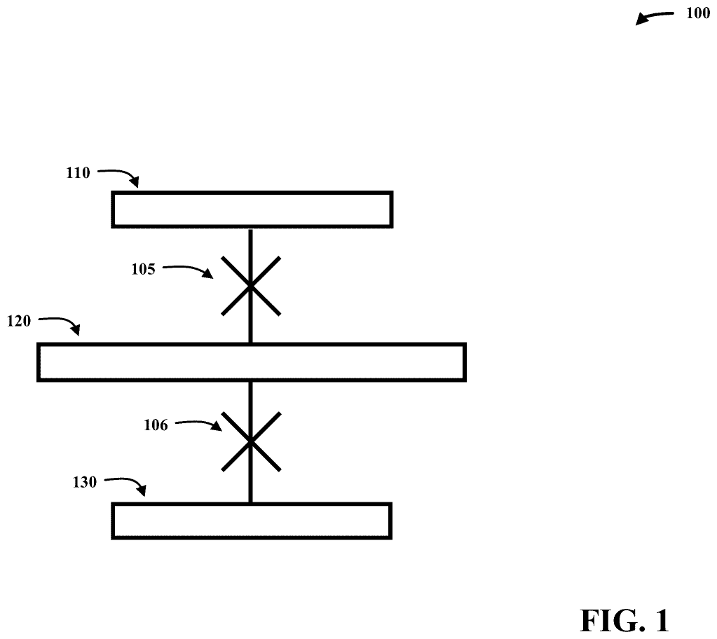

FIG. 1 illustrates a top view of an example, non-limiting. TCQ interconnect 100 that can facilitate suppression of cross-talk in accordance with one or more embodiments described herein. Tunable coupled qubit (TCQ) interconnect 100 illustrated in FIG. 1 can comprise outer superconducting pads 110 and 130 and/or middle superconducting pad 120, wherein each of such superconducting pads can comprise an electrode. In this example, each of superconducting pads 110, 120 and 130 can comprise a superconducting film (e.g., a superconducting metal film) that can be formed on a substrate (e.g., a silicon (Si) substrate, etc.) using one or more semiconductor and/or superconductor device fabrication methods. TCQ interconnect 100 illustrated in FIG. 1 can further comprise a first Josephson Junction 105 coupled to outer superconducting pad 110 and middle superconducting pad 120 and a second Josephson Junction 106 coupled to outer pad 130 and middle superconducting pad 120. In this example, first Josephson Junction 105 and/or second Josephson Junction 106 can comprise one or more superconducting films (e.g., superconducting metal film(s)) and/or one or more non-superconducting films (e.g., normal metal film(s)) formed on a substrate (e.g., a silicon (Si) substrate, etc.).

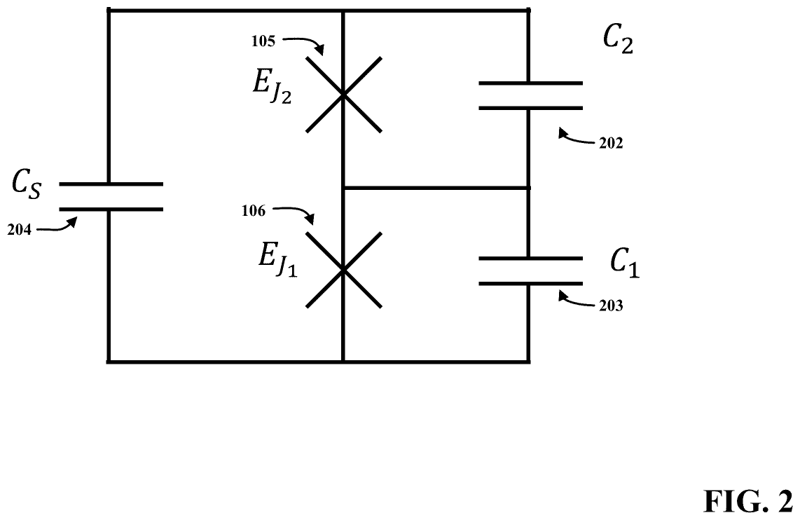

FIG. 2 illustrates an alternative top view of an example TCQ interconnect 100 that can facilitate suppression of cross-talk in accordance with one or more embodiments described herein. As illustrated, in FIG. 1, outer superconducting pad 110 can be capacitively coupled to middle superconducting pad 120, where such capacitive coupling is represented by a first capacitor 202 (denoted as C₂ in FIG. 2). Additionally, as illustrated, outer pad 130 and middle superconducting pad 120 can be capacitively coupled where such capacitive coupling is represented by a second capacitor (denoted as C₁ in FIG. 2). In this example embodiment, first capacitor 202 and second capacitor 203 represent direct capacitive shunting across first Josephson Junction 105 and second Josephson Junction 106, respectively. Accordingly, TCQ interconnect 100 can comprise two capacitively shunted Josephson Junctions, first Josephson Junction 105 and second Josephson Junction 106.

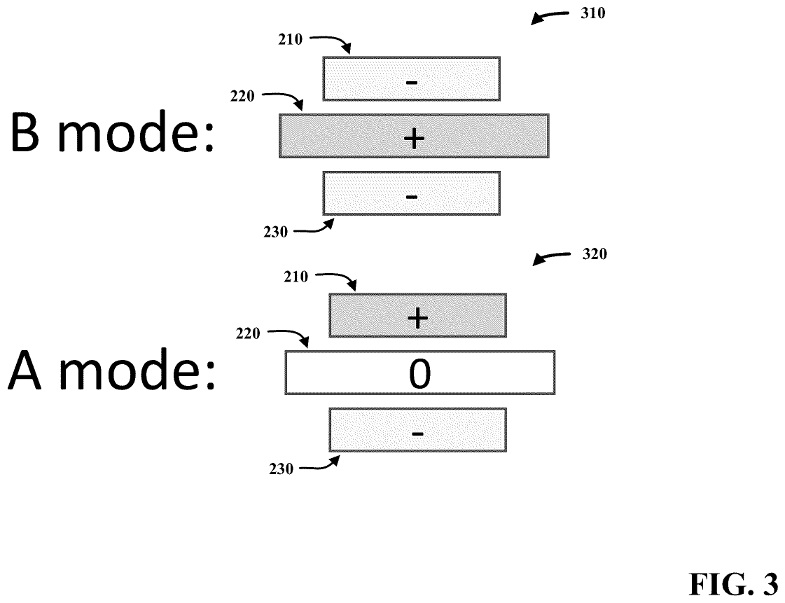

TCQ interconnect 100 can operate in a first oscillating mode (e.g., a first operating mode) and a second oscillating mode (e.g., a second operating mode) as shown in detail in FIG. 3. In some embodiments of the subject disclosure described herein, the first oscillating mode and the second oscillating mode can correspond to different (e.g., distinct) frequencies and/or different (e.g., distinct) spatial symmetries with respect to one another. In these embodiments, the first oscillating mode can be indicative of asymmetric excitations of first Josephson Junction 105 and second Josephson Junction 106, and the second oscillating mode can be indicative of symmetric excitations of first Josephson Junction 105 and second Josephson Junction 106. In these embodiments, such symmetric and asymmetric combinations of excitations associated with first Josephson Junction 105 and second Josephson Junction 106 can result from a capacitive coupling of outer superconducting pad 110 and outer superconducting pad 130, where such capacitive coupling is represented in FIG. 2 as a third capacitor 204 (denoted as Cₛ in FIG. 2).

In the example embodiment, third capacitor 204 represents the capacitive coupling between outer superconducting pad 110 and outer pad 130 of TCQ interconnect 100, where such capacitive coupling can enable creation of the first oscillating mode and the second oscillating mode having different frequencies and different spatial symmetries relative to one another as described above. In this example embodiment, such capacitive coupling represented as third capacitor 204 in FIG. 2 can enable the first oscillating mode and the second oscillating mode to interact with each other, where such modes would otherwise be isolated across first Josephson Junction 105 and second Josephson Junction 106 of TCQ interconnect 100. In this example embodiment, such interaction between the first oscillating mode and the second oscillating mode can enable creation of extended states (e.g., hybridized quantum states, hybridized oscillating modes, etc.) of TCQ interconnect 100 (e.g., hybridized quantum states and/or hybridized oscillating modes corresponding to different frequencies and different spatial symmetries).

The first oscillating mode and the second oscillating mode can respectively correspond to a first oscillating mode structure 320 (denoted as A mode in FIG. 3) and a second oscillating mode structure 310 (denoted as B mode in FIG. 3). In the example embodiment shown in FIG. 3, first oscillating mode structure 320 and second oscillating mode structure 310 can each define a certain coupling technique (e.g., coupling scheme, coupling arrangement, coupling pattern, etc.) that can be used to encode and/or store quantum information in the first oscillating mode and/or second oscillating mode of TCQ interconnect 100.

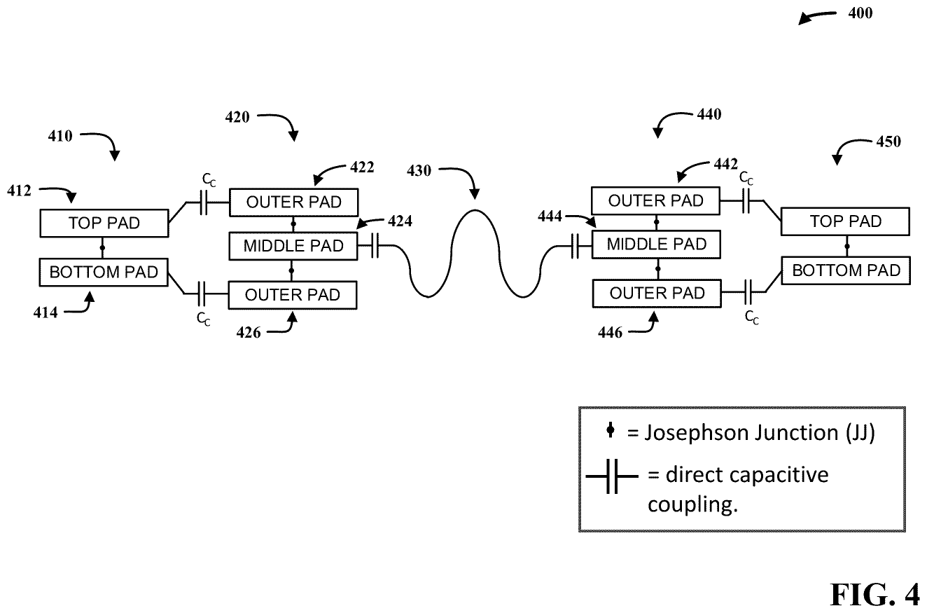

FIG. 4 illustrates a top view of an example, non-limiting device 400 that can facilitate suppression of cross-talk between qubits in accordance with one or more embodiments described herein. As shown, device 400 can comprise a first transmon data qubit 410 comprising a top superconducting pad 412 and a bottom superconducting pad 414 coupled by a Josephson Junction. In an example embodiment, top superconducting pad 412 and/or bottom superconducting pad 414 can comprise a superconducting film (e.g., a superconducting metal film) that can be formed on a substrate (e.g., a silicon (Si) substrate, etc.) using one or more semiconductor and/or superconductor device fabrication techniques. First transmon data qubit 410 can be coupled to first TCQ interconnect 420, wherein each pad of first transmon data qubit 410 (e.g., top pad 412 and bottom pad 414) are coupled to corresponding outer pads (e.g., outer pads 422 and 426) of first TCQ interconnect 420 by coupling capacitors (denoted as Ce in FIG. 4). Furthermore, middle pad 424 of first TCQ interconnect 420 can be coupled to coplanar waveguide resonator 430. Similarly, second transmon data qubit 450 can be coupled to second TCQ interconnect 440, wherein each pad of second transmon data qubit 450 are coupled to corresponding outer pads (e.g., outer pads 442 and 446) of second TCQ interconnect 440 by coupling capacitors. Additionally, middle pad 444 of second TCQ interconnect 440 can be coupled to coplanar waveguide resonator 430. In this example, first TCQ interconnect 420 and second TCQ interconnect 440 can comprise a first oscillating mode structure and a second oscillating mode structure as described above in detail in reference to FIGS. 1-3.

As first transmon data qubit 410 is coupled to the outer pads of first TCQ interconnect 420 by coupling capacitors, first transmon data qubit 410 has exchange coupling with the first oscillating mode of first TCQ interconnect 420, while coplanar waveguide resonator 430 has exchange coupling with the second oscillating mode of first TCQ interconnect 420. Similarly, as second transmon data qubit 450 is coupled to the outer pads of second TCQ interconnect 440 by coupling capacitors, second transmon data qubit 450 has exchange coupling with the first oscillating mode of second TCQ interconnect 440, while coplanar waveguide resonator 430 has exchange coupling with the second oscillating mode of second TCQ interconnect 440. This mode-selective coupling ensures that no exchange coupling exists between first transmon data qubit 410 and second transmon data qubit 450, thus suppressing cross-talk between first transmon data qubit 410 and second transmon data qubit 450, while still allowing for fast entangling gates between the first transmon data qubit 410 and the second transmon data qubit 450. For example, the resonator can be driven at its red or blue-side band, while Rabi-driving the first transmon data qubit 410 and/or the second transmon data qubit 450 to produce an entangling gate. The longitudinal interactions between the resonator and the data qubits of approximately 1 MHz ensures that a fast entangling gate is achieved.

In the above example, coupling capacitances can be utilized such that couplings between the transmon data qubits and corresponding TCQ interconnects and between the TCQ interconnects and the coplanar waveguide resonator are within a defined range of between 100 and 200 MHz. The first transmon data qubit and the second transmon data qubit can comprise frequencies within a defined range of 4.5 and 5 GHZ. In some embodiments the first oscillating mode structure can comprise an operating frequency less than an operating frequency of the second oscillating mode structure. For example, the first oscillating mode structure can comprise a frequency of approximately 5.6 GHZ and the second oscillating mode structure can comprise a frequency of approximately 9.4 GHz. The coplanar waveguide resonator 430 can comprise a resonance frequency of approximately 7 GHZ. Use of these frequencies can lead to device 400 having transmon-to-transmon longitudinal interaction of 0.05 kHz, transmon-resonator longitudinal interaction of approximately 1.3 MHZ, and transmon-to-transmon interaction of approximately 15 Hz. Furthermore, in one or more embodiments resonator 430 can be substituted for a multimode resonator.

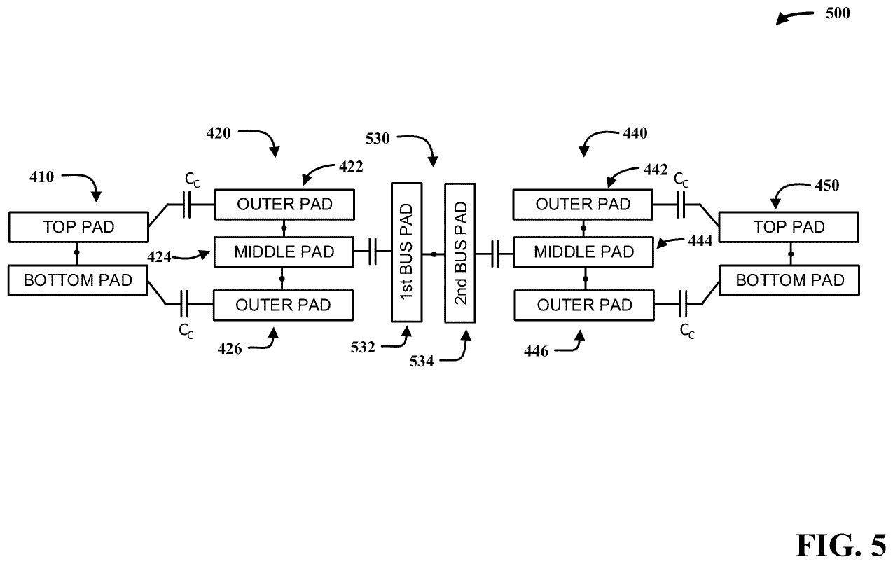

FIG. 5 illustrates a top-down view of an example, non-limiting device 500 that can facilitate suppression of cross-talk between qubits in accordance with one or more embodiments described herein. Device 500 can comprise a first transmon data qubit 410, a first TQC interconnect 420, a second TCQ interconnect 440 and a second transmon data qubit 450 as described above in reference to FIG. 4. However, rather than utilizing a coplanar waveguide to couple first TCQ interconnect 420 to second TCQ interconnect 440 as in device 400, device 500 can comprise a bus transmon 530 that couples first TCQ interconnect 420 to second TCQ interconnect 440. As shown, bus transmon 530 can comprise a first superconducting bus pad 532 coupled to first TCQ interconnect 420 and a second superconducting bus pad 534 coupled to second TCQ interconnect 440. Similarly to coplanar waveguide resonator 430, as described above in relation to FIG. 4, bus transmon 530 only has exchange coupling to first TCQ interconnect 420 and to second TCQ interconnect 440 while they are in their respective second oscillating mode structures. Accordingly, an entangling gate can be achieved between first transmon data qubit 410 and second transmon data qubit 450 of device 500 in the same manner as described above in relation to FIG. 4, while suppressing cross-talk by preventing exchange coupling between first transmon data qubit 410 and second transmon data qubit 450. Furthermore, bus transmon 530 yields a higher quality factor than is typically achieved with coplanar waveguide resonators and reduces the possibility of populating the resonator with long-lived photons, thereby improving device performance. In one or more embodiments, bus transmon 530 can comprise a frequency of approximately 7 GHZ. It should be appreciated that while FIGS. 4 and 5 discuss utilization of transmon qubits, use of any superconducting qubit that permits mode-selective coupling to a TCQ interconnect is envisioned. For example, in one or more embodiments, first transmon data qubit 410, second transmon data qubit 450 and/or bus transmon 530 can be replaced by capacitively shunted flux qubit (CSFQ), a fluxonium qubit, other tunable coupled qubits, and/or another form of superconducting qubit.

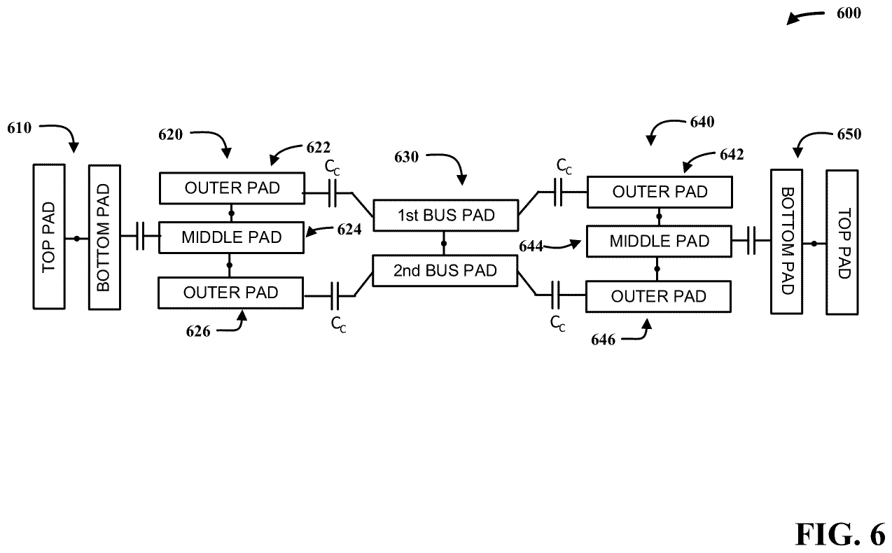

FIG. 6 illustrates a top-down view of an example, non-limiting, device 600 that facilitates suppression of cross-talk wherein use of the first oscillating mode structure and the second oscillating mode structure is reversed.

As shown, device 600 can comprises a first transmon data qubit 610 coupled to a middle superconducting pad 624 of first TCQ interconnect 620, wherein each superconducting pad of bus transmon 630 are coupled to corresponding outer pads (e.g., outer pads 622 and 626) of first TCQ interconnect 620. Similarly, device 600 can comprise a second transmon data qubit 650 coupled to a middle superconducting pad 644 of second TCQ interconnect 640, wherein each superconducting pad of bus transmon 630 are coupled to corresponding outer pads (e.g., outer pads 642 and 646) of second TCQ interconnect 640.

As first transmon data qubit 610 is coupled to the middle pad of first TCQ interconnect 620 by direct capacitive coupling, first transmon data qubit 610 has exchange coupling with the second oscillating mode of first TCQ interconnect 620, while bus transmon 630 has exchange coupling with the first oscillating mode of first TCQ interconnect 620. Similarly, as second transmon data qubit 650 is coupled to the middle pad of second TCQ interconnect 640 by direct capacitive coupling, second transmon data qubit 650 has exchange coupling with the second oscillating mode of second TCQ interconnect 640, while transmon bus 630 has exchange coupling with the first oscillating mode of second TCQ interconnect 640. This mode-selective coupling ensures that no exchange coupling exists between first transmon data qubit 610 and second transmon data qubit 650, thus suppressing cross-talk between first transmon data qubit 610 and second transmon data qubit 650, while still allowing for establishment of entangling gates between first transmon data qubit 610 and second transmon data qubit 650. For example, the bus transmon 630 can be driven at its red or blue-side band, while Rabi-driving the first transmon data qubit 610 and/or the second transmon data qubit 650 to produce an entangling gate. The longitudinal interactions between the resonator and the data qubits of approximately 1 MHz ensures that a fast entangling gate is achieved.

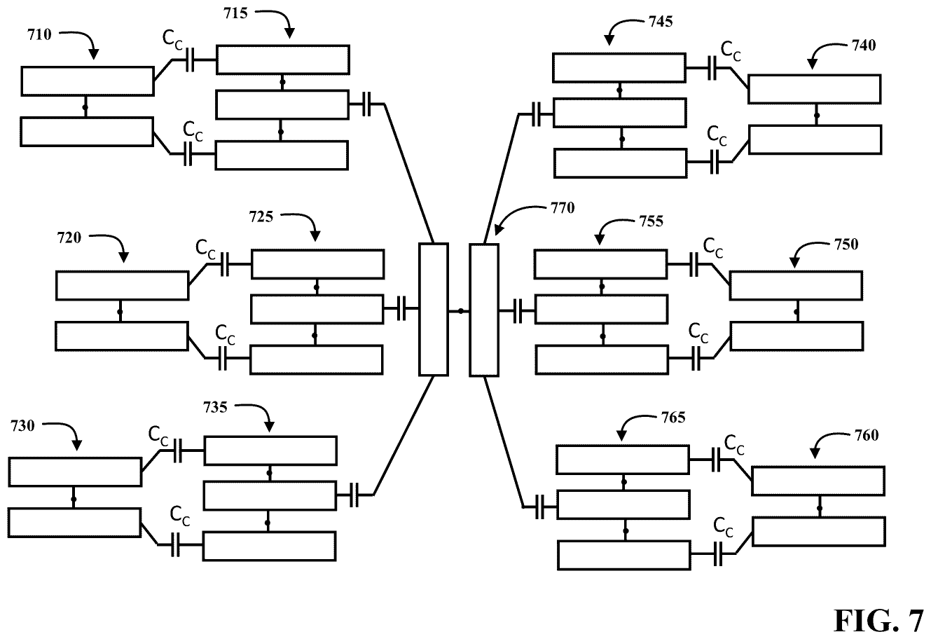

FIG. 7 illustrates a top-down view of an example, non-limiting device that facilitates all-to-all connectivity between multiple qubits with suppression of cross-talk in accordance with one or more embodiments described herein. As shown, device 700 can comprise a first data qubit 710 coupled to a first TCQ interconnect 715, a second data qubit 720 coupled to a second TCQ interconnect 725, a third data qubit 730 coupled to a third TCQ interconnect 735, a fourth data qubit 740 coupled to a fourth TCQ interconnect 745, a fifth data qubit 750 coupled to a fifth TCQ interconnect 755, and a sixth data qubit 760 coupled to a sixth TCQ interconnect 765, wherein the data quits are coupled to their respective TCQ interconnects as described in greater detail in reference to FIGS. 4 and 5 and wherein the TCQ interconnects are coupled to bus transmon 770 as described in greater detail in reference to FIGS. 4 and 5. Accordingly, each of the data qubits has exchange coupling with the first oscillating mode structure of their respective TCQ interconnects, while the bus transmon 770 only has exchange coupling to the second oscillating mode structure of the respective TCQ interconnects. Therefore, no exchange coupling exists between the data qubits, thus suppressing cross-talk, while entanglement gates can still be operated between one or more of the data qubits by driving bus transmon 770 at its red or blue side-band while Rabi-driving the desired data qubits.

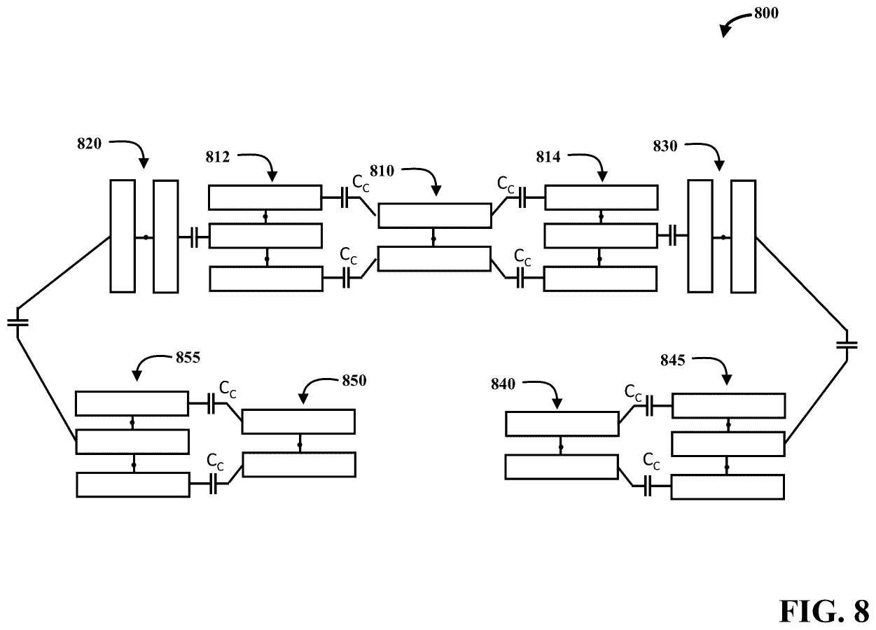

FIG. 8 illustrates a top-down view of an example, non-limiting, device 800 that facilitates suppression of cross-talk of qubits and scalability of number of qubits in accordance with one or more embodiments described herein.

As shown device 800 can comprises a first transmon data qubit 810 coupled to a first TCQ interconnect 812 and a second TCQ interconnect 814, wherein each pad of first transmon data qubit 810 is coupled to corresponding outer pads of first TCQ interconnect 812 and second TCQ interconnect 814. First TCQ interconnect 812 can be coupled to first bus transmon 820 and second TCQ interconnect 814 can be coupled to second bus transmon 830 respectively. Furthermore, device 800 can comprise a third transmon data qubit 850 coupled to a third TCQ interconnect 855 and a fourth transmon data qubit 840 coupled to a fourth TCQ interconnect 845, wherein third TCQ interconnect 855 is coupled to first bus transmon 820 and wherein fourth TCQ interconnect 845 is coupled to second bus transmon 830. In this manner, transmon data qubits can be coupled to multiple buses via multiple TCQ interconnects, thus enabling greater scalability of qubit devices that facilitate suppression of cross-talk.

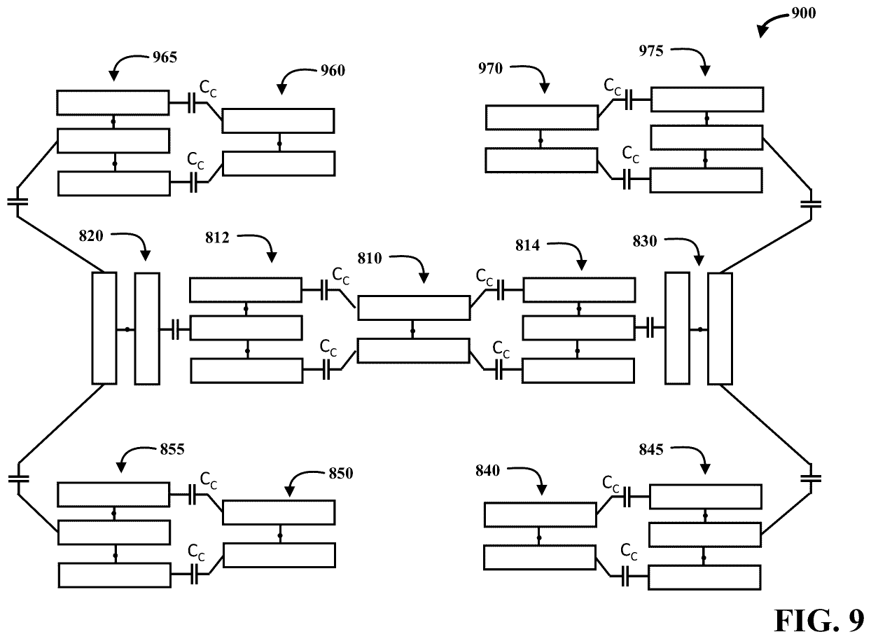

FIG. 9 illustrates a top-down view of an example, non-limiting, device 900 that facilitates suppression of cross-talk of qubits and scalability of number of qubits in accordance with one or more embodiments described herein.

As shown device 900 can comprises a first transmon data qubit 810 coupled to a first TCQ interconnect 812 and a second TCQ interconnect 814, wherein each pad of first transmon data qubit 810 is coupled to corresponding outer pads of first TCQ interconnect 812 and second TCQ interconnect 814. First TCQ interconnect 812 can be coupled to first bus transmon 820 and second TCQ interconnect 814 can be coupled to second bus transmon 830 respectively. Furthermore, device 800 can comprise a third transmon data qubit 850 coupled to a third TCQ interconnect 855, a fourth transmon data qubit 840 coupled to a fourth TCQ interconnect 845 a fifth transmon data qubit 970 coupled to a fifth TCQ interconnect 975 and a sixth transmon data qubit 960 coupled to a sixth TCQ interconnect 965. In this example, third TCQ interconnect 855 and sixth TCQ interconnect 965 can be coupled to first bus transmon 820 and fourth TCQ interconnect 845 and fifth TCQ interconnect 975 can be coupled to second bus transmon 830. In this manner, transmon data qubits can be coupled to multiple buses via multiple TCQ interconnects, thus enabling greater scalability of qubit devices that facilitate suppression of cross-talk.

The various embodiments of the subject disclosure described herein and/or illustrated in the figures (e.g., devices 100, 400, 500, 600, 700, 800, 900, etc.) can be coupled to one or more external devices (not illustrated in FIGS. 1-9) to facilitate operation of such embodiments. For example, with reference to FIG. 4, device 400, first transmon data qubit 410, first TCQ interconnect 420, coplanar waveguide resonator 430, second TCQ interconnect 440 and/or second transmon data qubit 450 can be coupled to one or more external devices that can be external to device 400, such as for instance, a pulse generator device, an electrical power source, and/or a field generator.

In an example embodiment, although not depicted in FIG. 4, device 400, first transmon data qubit 410, first TCQ interconnect 420, coplanar waveguide resonator 430, second TCQ interconnect 440 and/or second transmon data qubit 450 can be coupled to a pulse generator device including, but not limited to, an arbitrary waveform generator (AWG), a vector network analyzer (VNA), and/or another pulse generator device that can be external to device 400 and can transmit and/or receive pulses (e.g., microwave pulses, microwave signals, control signals, etc.) to and/or from device 400, first transmon data qubit 410, first TCQ interconnect 420, coplanar waveguide resonator 430, second TCQ interconnect 440 and/or second transmon data qubit 450. In another example embodiment, although not depicted in FIG. 4, device 400, first transmon data qubit 410, first TCQ interconnect 420, coplanar waveguide resonator 430, second TCQ interconnect 440 and/or second transmon data qubit 450 can be coupled to an electrical power source and/or a magnetic field generator that can be external to device 400 and can provide an electrical current, an electrical potential, and/or a magnetic field to device 400, first transmon data qubit 410, first TCQ interconnect 420, coplanar waveguide resonator 430, second TCQ interconnect 440 and/or second transmon data qubit 450.

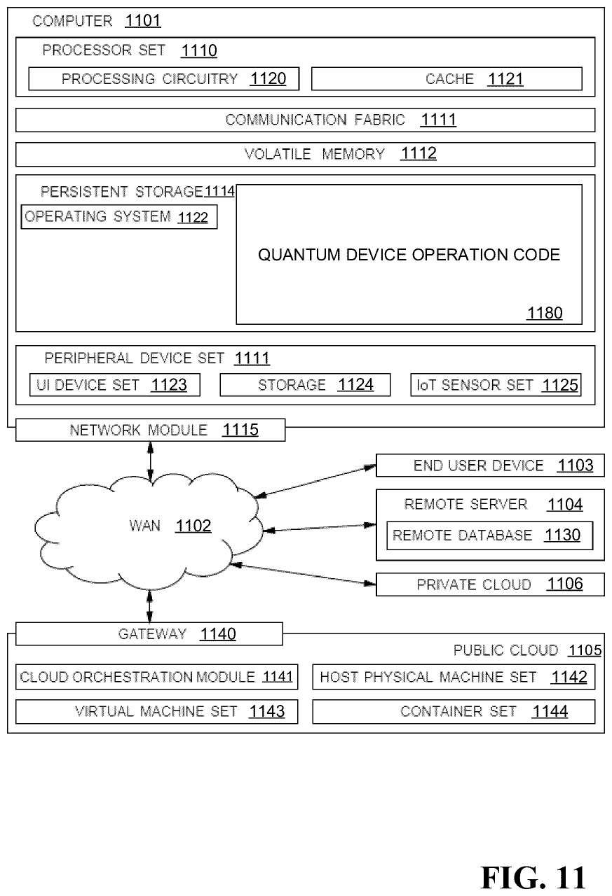

In the example embodiments above, such one or more external devices (e.g., a pulse generator device (e.g., an AWG, a VNA, etc.), an electrical power source, and/or a magnetic field generator) can also be coupled to a computer (e.g., computer 1101 described below with reference to FIG. 11) comprising a memory (e.g., memory 1112 and/or persistent storage 1114 described below with reference to FIG. 11) that can store instructions thereon (e.g., software, routines, processing threads, etc.) and a processor (e.g., processor set 1110 described below with reference to FIG. 11) that can execute such instructions that can be stored on the memory. In these example embodiments, such a computer can be employed to operate and/or control (e.g., via processor set 1110 executing instructions stored on memory 1112 and/or persistent storage 1114) such one or more external devices (e.g., a pulse generator device (e.g., an AWG, a VNA, etc.), an electrical power source, and/or a magnetic field generator). For instance, in these example embodiments, such a computer can be employed to enable one or more external devices (e.g., a pulse generator device (e.g., an AWG, a VNA, etc.), an electrical power source, and/or a magnetic field generator) to: a) transmit and/or receive pulses (e.g., microwave pulses, microwave signals, control signals, etc.) to and/or from device 400, first transmon data qubit 410, first TCQ interconnect 420, coplanar waveguide resonator 430, second TCQ interconnect 440 and/or second transmon data qubit 450 and/or b) provide an electrical current, an electrical potential, and/or a magnetic field to device 400, first transmon data qubit 410, first TCQ interconnect 420, coplanar waveguide resonator 430, second TCQ interconnect 440 and/or second transmon data qubit 450.

In various embodiments, an entity that implements devices 400, 500, 600, 700, 800 and/or 900 (e.g., an entity such as, for instance, a human, a computing device, a software application, an agent, a machine learning model, an artificial intelligence model, etc.) can implement one or more of the entangling gate schemes described herein in accordance with one or more embodiments of the subject disclosure. In these embodiments, such an entity can implement one or more of such entangling gate schemes by setting and/or adjusting one or more coupling capacitances between coplanar waveguide resonator 430/bus transmon 530 and the one or more superconducting pads of first TCQ interconnect 420 and second TCQ interconnect 440 such that one or more of such mode-selective schemes are achieved. In these embodiments, such an entity can set and/or adjust such one or more coupling capacitances (e.g., coupling capacitances of capacitors denoted as Cc in FIGS. 4-9) by applying and/or adjusting (e.g., via one or more of the above defined external devices and/or computer 1101 as described above) a magnetic field, an electrical current, an electrical potential, and/or a microwave pulse applied to devices 400, 500, 600, 700, 800 and 900 and/or one or more components thereof.

Fabrication of the various embodiments of the subject disclosure described herein and/or illustrated in the figures (e.g., device 100, device 400, device 500, etc.) can comprise multi-step sequences of, for example, photolithographic and/or chemical processing steps that facilitate gradual creation of electronic-based systems, devices, components, and/or circuits in a semiconducting and/or a superconducting device (e.g., an integrated circuit). For instance, the various embodiments of the subject disclosure described herein and/or illustrated in the figures (e.g., device 100, device 400, device 500, etc.) can be fabricated on a substrate (e.g., a silicon (Si) substrate, etc.) by employing techniques including, but not limited to: photolithography, microlithography, nanolithography, nanoimprint lithography, photomasking techniques, patterning techniques, photoresist techniques (e.g., positive-tone photoresist, negative-tone photoresist, hybrid-tone photoresist, etc.), etching techniques (e.g., reactive ion etching (RIE), dry etching, wet etching, ion beam etching, plasma etching, laser ablation, etc.), evaporation techniques, sputtering techniques, plasma ashing techniques, thermal treatments (e.g., rapid thermal anneal, furnace anneals, thermal oxidation, etc.), chemical vapor deposition (CVD), atomic layer deposition (ALD), physical vapor deposition (PVD), molecular beam epitaxy (MBE), electrochemical deposition (ECD), chemical-mechanical planarization (CMP), backgrinding techniques, and/or another technique for fabricating an integrated circuit.

The various embodiments of the subject disclosure described herein and/or illustrated in the figures (e.g., device 100, device 400, device 500, etc.) can be fabricated using various materials. For example, the various embodiments of the subject disclosure described herein and/or illustrated in the figures (e.g., device 100, device 400, device 500, etc.) can be fabricated using materials of one or more different material classes including, but not limited to: conductive materials, semiconducting materials, superconducting materials, dielectric materials, polymer materials, organic materials, inorganic materials, non-conductive materials, and/or another material that can be utilized with one or more of the techniques described above for fabricating an integrated circuit.

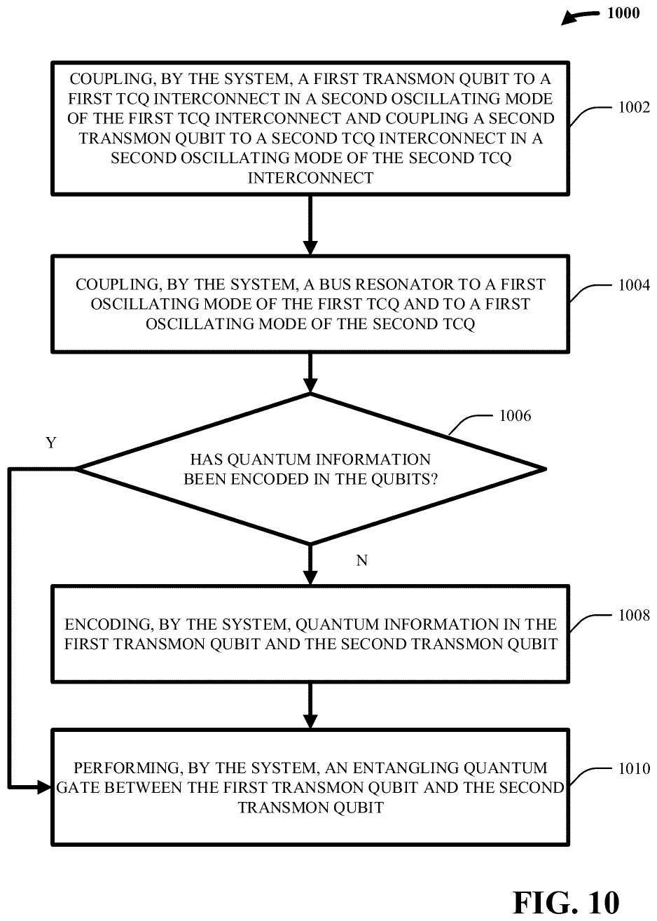

FIG. 10 illustrates a flow diagram of an example, non-limiting computer-implemented method 1000 can facilitate cross-talk suppression between qubits in accordance with one or more embodiments described herein.

At 1002, computer-implemented method 1000 can comprise coupling, by a system (e.g., a system comprising device 400, device 500 etc. and/or one of more types of external devices defined above), operatively coupled to a processor (e.g., processing unit 1204, etc.) a first transmon qubit to a first TCQ interconnect in a first oscillating mode of the first TCQ interconnect and coupling a second transmon qubit to a second TCQ interconnect in a first oscillating mode of the second TCQ interconnect.

At 1004, computer-implemented method 1000 can comprise coupling, by the system (e.g., a system comprising device 400, device 500 etc. and/or one of more types of external devices defined above), a resonator bus (e.g., coplanar waveguide resonator 430 and/or bus transmon 530) to a second oscillating mode of the first TCQ interconnect and to the second oscillating mode of the second TCQ interconnect.

At 1006, computer-implemented method 1000 can comprise determining, by the system (e.g., a system comprising device 400, device 500 etc. and/or one of more types of external devices defined above, if quantum information has been encoded in the first transmon qubit and/or the second transmon qubit. If quantum information has been encoded, then method 1000 can proceed to step 1010. If quantum information has not been encoded, then method 1000 can proceed to step 1008 and encode quantum information within the first transmon qubit and/or the second transmon qubit before processing to step 1010.

At 1010, computer-implemented method 1000 can comprise performing, by the system (e.g., a system comprising device 400, device 500 etc. and/or one of more types of external devices defined above), an entangling quantum gate between the first transmon qubit and the second transmon qubit. For example, as described above in reference to FIGS. 4-9, an entangling gate can be performed by driving the resonator bus (e.g., coplanar waveguide resonator 430 and/or bus transmon 530) at its red or blue side-band while Rabi-driving the transmon qubits. In this manner, an entangling gate can be performed while suppressing cross-talk of the first transmon qubit and the second transmon qubit.

A practical application of the devices described herein is that they allow for mode selective coupling of qubits to perform entangling gates without constant exchange coupling, thereby suppressing cross-talk between qubits. By suppressing cross-talk between qubits, unwanted excitations of qubits and unintended shifting of transition frequencies can be minimized or eliminated, thereby reducing error and improving performance (e.g., speed, and/or accuracy) of quantum operations performed by the devices described herein.

FIG. 11 and the following discussion are intended to provide a brief, general description of a suitable computing environment 1100 in which one or more embodiments described herein at FIG. 10 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as translation of an original source code based on a configuration of a target system by the quantum device operation code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1180, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method can be distributed among multiple computers and/or between multiple locations. On the other hand, in this presentation of computing environment 1100, detailed discussion is focused on a single computer, specifically computer 1101, to keep the presentation as simple as possible. Computer 1101 can be located in a cloud, even though it is not shown in a cloud in FIG. 11. On the other hand, computer 1101 is not required to be in a cloud except to any extent as can be affirmatively indicated.

PROCESSOR SET 1110 includes one, or more, computer processors of any type now known or to be developed in the future. Processing circuitry 1120 can be distributed over multiple packages, for example, multiple, coordinated integrated circuit chips. Processing circuitry 1120 can implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set can be located “off chip.” In some computing environments, processor set 1110 can be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods can be stored in block 1180 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory can be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 can be a read only memory (ROM), but typically at least a portion of the persistent storage allows writing of data, deletion of data and re-writing of data. Some familiar forms of persistent storage include magnetic disks and solid-state storage devices. Operating system 1122 can take several forms, such as various known proprietary operating systems or open-source Portable Operating System Interface type operating systems that employ a kernel. The code included in block 1180 typically includes at least some of the computer code involved in performing the inventive methods.

PERIPHERAL DEVICE SET 1114 includes the set of peripheral devices of computer 1101. Data communication connections between the peripheral devices and the other components of computer 1101 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 can include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 can be persistent and/or volatile. In some embodiments, storage 1124 can take the form of a quantum computing storage device for storing data in the form of qubits. In embodiments where computer 1101 is required to have a large amount of storage (for example, where computer 1101 locally stores and manages a large database) then this storage can be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor can be a thermometer and another sensor can be a motion detector.

NETWORK MODULE 1115 is the collection of computer software, hardware, and firmware that allows computer 1101 to communicate with other computers through WAN 1102. Network module 1115 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and can take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 can be a client device, such as thin client, heavy client, mainframe computer and/or desktop computer.

REMOTE SERVER 1104 is any computer system that serves at least some data and/or functionality to computer 1101. Remote server 1104 can be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data can be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs can be stored as images and can be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware and firmware allowing public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer-implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A device comprising:
a first transmon qubit coupled to a first tunable coupled qubit (TCQ) interconnect, wherein each pad of the first transmon qubit are coupled to corresponding outer pads of the first TCQ interconnect;
a second transmon qubit coupled to a second TCQ interconnect, wherein each pad of the second transmon qubit are coupled to corresponding outer pads of the second TCQ interconnect; and
a middle pad of the first TCQ interconnect coupled to a middle pad of the second TCQ interconnect, wherein the coupling comprises each middle pad coupled to a resonator.

2. The device of claim 1, wherein the resonator comprises a waveguide.

3. The device of claim 1, wherein the resonator comprises a superconducting qubit.

4. The device of claim 3, wherein the superconducting qubit comprises at least one of a capacitively shunted flux qubit, a fluxonium qubit, or a tunable coupled qubit.

5. The device of claim 1, further comprising a third transmon qubit coupled to a third TCQ interconnect, wherein each pad of the third transmon qubit are coupled corresponding outer pads of the third TCQ interconnect, and wherein a middle pad of the third TCQ interconnect is coupled to the resonator.

6. The device of claim 1, wherein the resonator comprises a multimode resonator.

7. A device comprising:
a transmon qubit coupled to a first TCQ interconnect and a second TCQ interconnect, wherein each pad of the transmon qubit are coupled to corresponding outer pads of the first TCQ interconnect and corresponding outer pads of the second TCQ interconnect;
a first resonator bus coupled to a middle pad of the first TCQ interconnect; and
a second resonator bus coupled to a middle pad of the second TCQ interconnect.

8. The device of claim 7, wherein at least one of the first resonator bus or the second resonator bus comprises a waveguide.

9. The device of claim 7, wherein at least one of the first resonator bus or the second resonator bus comprises a superconducting qubit.

10. The device of claim 9, wherein the superconducting qubit comprises at least one of a capacitively shunted flux qubit, a fluxonium qubit, or a tunable coupled qubit.

11. The device of claim 7, wherein the first TCQ interconnect comprises a first operating mode that enables exchange coupling between the transmon qubit and the first TCQ interconnect and a second operating mode that enables exchange coupling between the first TCQ interconnect and the first resonator bus.

12. The device of claim 7, wherein the second TCQ interconnect comprises a first operating mode that enables exchange coupling between the transmon qubit and the second TCQ interconnect and a second operating mode that enables exchange coupling between the second TCQ interconnect and the second resonator bus.

13. The device of claim 7, wherein the first resonator bus and the second resonator bus comprise multimode resonators.

14. A device comprising:
a transmon bus comprising a first pad and a second pad; and
a TCQ interconnect, wherein the first pad of the transmon bus is coupled to a middle pad of the TCQ interconnect.

15. The device of claim 14, further comprising:
a second TCQ interconnect, wherein the second pad of the transmon bus is coupled to a middle pad of the second TCQ interconnect.

16. The device of claim 15, further comprising:
a third TCQ interconnect, wherein the first pad of the transmon bus is coupled to a middle pad of the third TCQ interconnect; and
a fourth TCQ interconnect, wherein the second pad of the transmon bus is coupled to a middle pad of the fourth TCQ interconnect.

17. The device of claim 14, further comprising:
a transmon qubit coupled to outer pads of the TCQ interconnect, wherein the TCQ interconnect comprises a first Josephson junction and a second Josephson junction.

18. The device of claim 17, wherein the TCQ interconnect comprises a first operating mode comprising asymmetric combinations of excitations associated with the first Josephson junction and the second Josephson junction, and a second operating mode comprising symmetric combinations of excitations associated with the first Josephson junction and the second Josephson junction.

19. The device of claim 18, wherein the first operating mode enables exchange coupling between the transmon qubit and the TCQ interconnect, and wherein the second operating mode enables exchange coupling between the TCQ interconnect and the resonator bus.

20. The device of claim 19, wherein the first operating mode comprises a first operating frequency and the second operating mode comprises a second operating frequency, wherein the second operating frequency is greater than the first operating frequency.
